(19) United States
(12) Patent Application Publication
(10) Pub. No.: US 2015/0059474 A1
(43) Pub. Date: Mar. 5, 2015

(54) FUNCTIONAL DEVICE, ELECTRONIC APPARATUS, AND MOVING OBJECT

(71) Applicant: Seiko Epson Corporation, Tokyo (JP)

(72) Inventor: Satoru TANAKA, Chino (JP)

(21) Appl. No.: 14/468,632

(22) Filed: Aug. 26, 2014

(30) Foreign Application Priority Data
Aug. 29, 2013 (JP) 2013-177655

(51) Int. Cl. G01P 15/125

(52) U.S. Cl. CPC G01P 15/125
USPC 73/514.32

(57) ABSTRACT

A functional device includes a movable member that can be displaced along a first axis, a movable electrode part extended from the movable member, a fixed electrode part provided to be opposed to the movable electrode part, and a stopper part that regulates displacement of the movable member. A projecting part projecting along the first axis is provided on the movable member, and a distance between an end of the projecting part and the stopper part is shorter than a distance between the movable electrode part and the fixed electrode part.

### CROSS-REFERENCE TO RELATED APPLICATIONS

This application claims priority to Japanese Patent Application No. 2013-177655 filed on Aug. 29, 2013. The entire disclosure of Japanese Patent Application No. 2013-177655 is hereby incorporated herein by reference.

### BACKGROUND

1. Technical Field

The present invention relates to a functional device, an electronic apparatus, and a moving object.

2. Related Art

In related art, as a functional device that detects a physical quantity of acceleration or the like used as a functional device, a functional device having a structure including a fixed electrode, a movable member that can be displaced in a fixed direction, and a movable electrode provided with a gap adjacent to the fixed electrode and provided on the movable member has been known.

In the functional device, the gap between the fixed electrode and the movable electrode provided on the movable member changes with displacement of the movable member, a change in capacitance caused between the fixed electrode and the movable electrode due to the change of the gap is detected, and thereby, a change of a physical quantity of acceleration or the like is measured.

For example, Patent Document 1 (U.S. Pat. No. 6,065,341) discloses a functional device having a structure in which a movable member, a beam part extended from the movable member, and a fixed part to which the beam part is connected are provided in line symmetry, and a stopper part that regulates displacement of the movable member is provided on a surface opposed to the movable member inside the beam part bent to form a polygonal shape.

However, in the above described functional device, displacement in a rotation direction generated in the movable member in a plan view of the movable member is not easily regulated. Therefore, when excessive acceleration or the like is applied and the displacement in the rotation direction is generated in the movable member, there is a problem that the fixed electrode and the movable electrode provided on the movable member come into contact and the capacitance generated between both of the electrodes is lost, and measurement as the functional device is stopped. Further, the electrodes may be broken due to contact between the fixed electrode and the movable electrode. The problems may occur not only in the functional device but also in an MEMS vibrator having the same configuration.

### SUMMARY

An advantage of some aspects of the invention is to solve at least a part of the problems described above, and the invention can be implemented as the following forms or application examples.

### Application Example 1

A functional device according to this application example includes a movable member that can be displaced along a first axis, a movable electrode part extended from the movable member, a fixed electrode part provided to be opposed to the movable electrode part, and a stopper part that regulates displacement of the movable member, wherein a projecting part projecting along the first axis is provided on the movable member, and a distance between an end of the projecting part and the stopper part is shorter than a distance between the movable electrode part and the fixed electrode part.

According to the functional device, when the movable member is displaced along the first axis, the projecting part projecting from the movable member and the stopper part come into contact before contact between the movable electrode part and the fixed electrode part, and thereby, contact between the movable electrode part and the fixed electrode part may be suppressed.

Thus, when a force of acceleration or the like is applied to the functional device and the movable member is excessively displaced, sticking between the electrode parts and breakage of the electrode parts due to contact between the fixed electrode part and the movable electrode part or the like may be suppressed. Further, the functional device that may suppress a loss of capacitance caused between the movable electrode part and the fixed electrode part and continuously measure the physical quantity of acceleration or the like may be obtained.

### Application Example 2

In the functional device according to the application example described above, it is preferable that a fixed part connected to the movable member is provided, and the fixed part and the stopper part are integrally provided.

According to the functional device, when the movable member is displaced along the first axis, the projecting part projecting from the movable member and the stopper part provided integrally with the fixed part come into contact before contact between the movable electrode part and the fixed electrode part, and thereby, contact between the fixed electrode part and the movable electrode part may be suppressed.

Thus, when a force of acceleration or the like is applied to the functional device and the movable member is excessively displaced, sticking between the electrode parts and breakage of the electrode parts due to contact between the fixed electrode part and the movable electrode part or the like may be suppressed. Further, the functional device that may suppress a loss of capacitance caused between the fixed electrode part and the movable electrode part and continuously measure the physical quantity of acceleration or the like may be obtained.

### Application Example 3

In the functional device according to the application example described above, it is preferable that a first fixed part and a second fixed part connected to the movable member are provided, and the first fixed part and the second fixed part are provided on both sides of the stopper part, and the first fixed part and the movable member are connected by a first beam part and the second fixed part and the movable member are connected by a second beam part.

According to the functional device, the movable member is fixed by the first beam part connected to the first fixed part and the second beam part connected to the second fixed part, and thereby, displacement of the movable member in an in-plane rotation direction in parallel to the first axis may be suppressed.

### Application Example 4

In the functional device according to the application example described above, it is preferable that at least a part of the projecting part is provided between the first beam part and the second beam part.

According to the functional device, when the displacement of the movable member in the in-plane rotation direction in parallel to the first axis is caused, the projecting part projecting from the movable member comes into contact with the first beam part and the second beam part, and thereby, the displacement in the in-plane rotation direction may be suppressed.

### Application Example 5

In the functional device according to the application example described above, it is preferable that the movable member and the stopper part are at the same potential.

According to the functional device, the stopper part and the movable member are at the same potential, and thereby, when the movable member comes into contact with the stopper part, fluctuations in capacitance between the fixed electrode part and the movable electrode part provided on the movable member may be suppressed. Therefore, when the movable member comes into contact with the stopper part, fluctuations in capacitance between the movable member and the fixed electrode part may be suppressed. Thus, the functional device in which an influence on the measurement of the physical quantity of acceleration or the like is suppressed even when the movable member and the stopper part come into contact may be obtained.

### Application Example 6

In the functional device according to the application example described above, it is preferable that a projection is provided on at least one of opposed surfaces of the stopper part and the projection part.

According to the functional device, compared to a contact area when the stopper part and the movable member come into contact, the contact area when the stopper part and the movable member come into contact in the case where the projection is provided on the movable member may be made smaller. Thereby, an impact when the stopper part and the movable member come into contact may be reduced. Further, sticking between the stopper part and the movable member may be suppressed. Therefore, sticking and breakage of the functional device when the stopper part and the movable member come into contact may be suppressed.

### Application Example 7

A functional device according to this application example includes a movable member that can be displaced along a first axis, a movable electrode part extended from the movable member, a fixed electrode part provided to be opposed to the movable electrode part, a stopper part that regulates displacement of the movable member, a first fixed part and a second fixed part provided on both sides of the stopper part, a first beam part that connects the first fixed part and the movable member, and a second beam part that connects the second fixed part and the movable member, wherein the stopper part is provided to project toward the movable member, and a distance between the stopper part and the movable member is shorter than a distance between the movable electrode part and the fixed electrode part.

According to the functional device, when the movable member is displaced along the first axis, the movable member and the stopper part projecting toward the movable member come into contact before contact between the movable electrode part and the fixed electrode part, and thereby, contact between the fixed electrode part and the movable electrode part may be suppressed.

Thus, when a force of acceleration or the like is applied to the functional device and the movable member is excessively displaced, sticking between the electrode parts and breakage of the electrode parts due to contact between the fixed electrode part and the movable electrode part or the like may be suppressed. Further, the functional device that may suppress a loss of capacitance caused between the fixed electrode part and the movable electrode part and continuously measure the physical quantity of acceleration or the like may be obtained.

### Application Example 8

An electronic apparatus according this application example includes any one of the above described functional devices.

According to the electronic apparatus, one of the above described functional devices is mounted. Even when an impact is applied to the electronic apparatus, breakage of the functional device may be suppressed and the physical quantity may be continuously detected, and thereby, the highly reliable electronic apparatus may be obtained.

### Application Example 9

A moving object according this application example includes any one of the above described functional devices.

According to the moving object, one of the above described functional devices is mounted. Breakage of the functional device due to an impact from the moving object may be suppressed and the physical quantity may be continuously detected, and thereby, the highly reliable moving object may be obtained.

### BRIEF DESCRIPTION OF THE DRAWINGS

The invention will be described with reference to the accompanying drawings, wherein like numbers reference like elements.

FIG. 1 is a plan view schematically showing a functional device according to a first embodiment.

FIG. 2 is an enlarged view showing a part of the functional device according to the first embodiment.

FIG. 3 is a plan view schematically showing a functional device according to a second embodiment.

FIG. 4 is an enlarged view showing a part of the functional device according to the second embodiment.

FIG. 5 is a plan view schematically showing a functional device according to a third embodiment.

FIG. 6 is an enlarged view showing a part of a functional device according to a fourth embodiment.

FIG. 7 is an enlarged view showing a part of a functional device according to a fifth embodiment.

FIG. 8 schematically shows a personal computer as an electronic apparatus according to a working example.

FIG. 9 schematically shows a cell phone as an electronic apparatus according to a working example.

FIG. 10 schematically shows a digital still camera as an electronic apparatus according to a working example.

FIG. 11 schematically shows an automobile as a moving object according to a working example.

### DESCRIPTION OF EXEMPLARY EMBODIMENTS

As below, embodiments of the invention will be explained using the drawings. Note that, in the following respective drawings, the dimensions and ratios of the respective component elements may be appropriately differentiated from the actual component elements so that the respective component elements may have sizes to the degrees that can be recognized on the drawings.

### First Embodiment

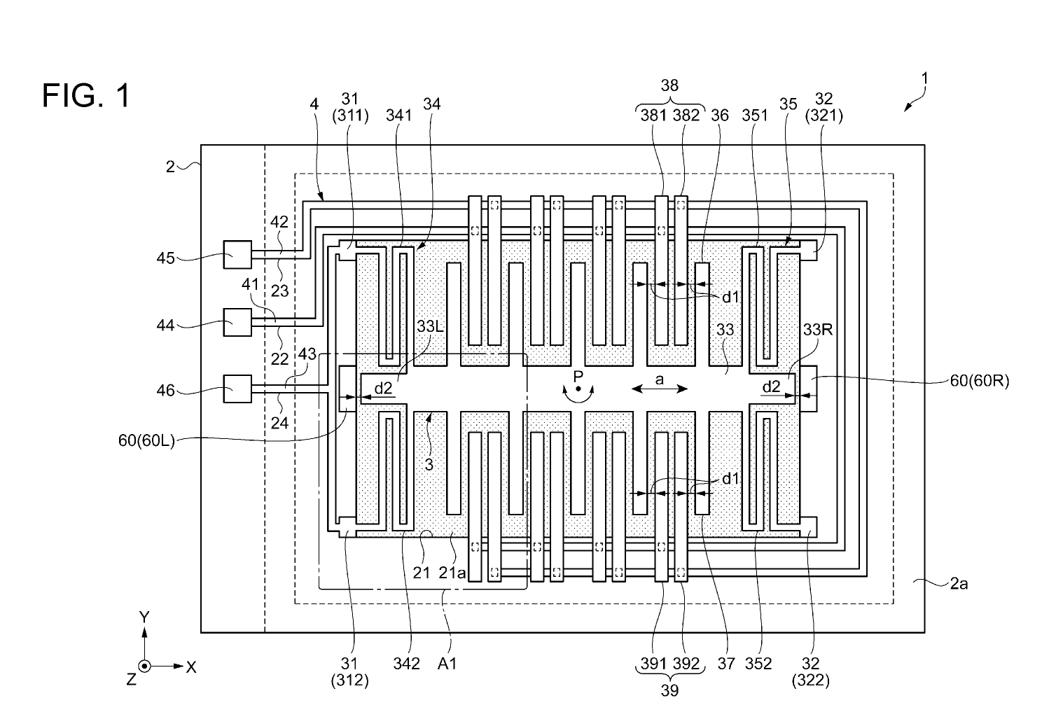

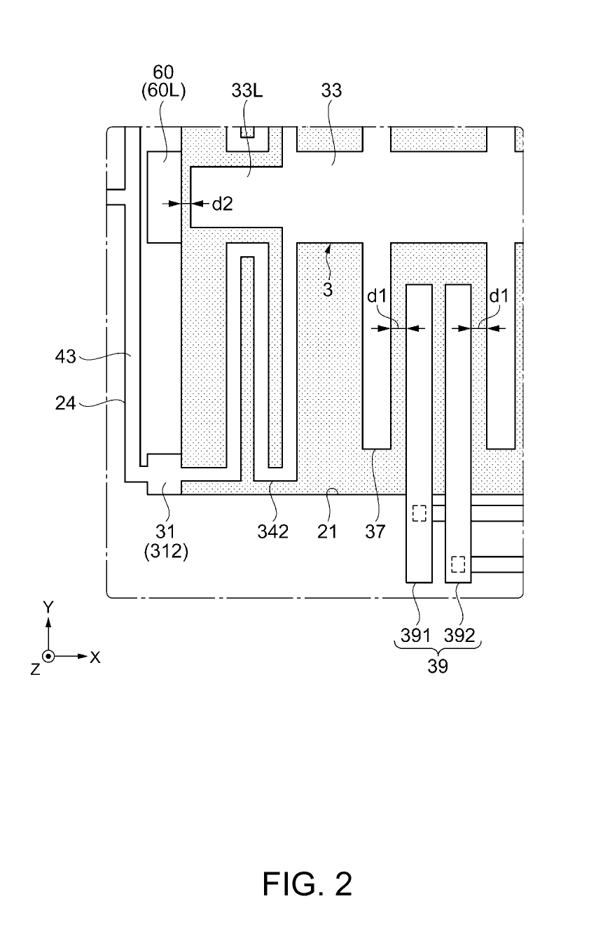

A functional device according to a first embodiment will be explained using FIGS. 1 and 2.

FIG. 1 is a plan view showing an outline of the functional device according to the first embodiment. FIG. 2 is an enlarged schematic diagram of a part shown by a dashed-dotted line A1 in FIG. 1. For convenience of explanation, illustration of a lid member is omitted in FIGS. 1 and 2. Further, in FIGS. 1 and 2, an X-axis, a Y-axis, and a Z-axis are shown as three axes orthogonal to one another, and the Z-axis is an axis indicating a thickness direction in which a substrate and a device part overlap.

### Structure of Functional Device 1

A functional device 1 of the embodiment shown in FIGS. 1 and 2 includes a substrate 2, a device part 3 provided on the substrate 2, and a wiring part 4 electrically connected to the device part 3.

In the functional device 1, a movable part 33 forming the device part 3 can move due to acceleration or the like applied to the functional device 1, and thereby, gaps d1 between fixed electrode parts 38, 39 provided on the substrate 2 and movable electrode parts 36, 37 provided on the movable part change. The acceleration or the like applied to the functional device 1 is measured according to the changes of the gaps d1.

As below, the respective parts forming the functional device 1 will be sequentially explained in detail.

### Substrate 2

The substrate 2 is provided to support the device part 3. The substrate 2 has a plate shape and a hollow part 21 is provided on a principal surface 2a on which the device part 3 is provided. The hollow part 21 is provided to house the movable part 33, the movable electrode parts 36, 37, and a first beam part 34, a second beam part 35 forming the device part 3, which will be described later, in a plan view of the substrate 2 from a perpendicular direction with respect to the principal surface 2a. Further, the hollow part 21 has an inner bottom 21a. The hollow part 21 forms a space in which contact between the movable part 33, the movable electrode parts 36, 37, and the first beam part 34, the second beam part 35 forming the device part 3 and the substrate 2 is suppressed, in other words, an avoidance part. Thereby, displacement of the movable part 33 may be allowed.

Note that the space may be provided as an opening part penetrating the substrate 2 in the thickness direction (Z-axis direction) in place of the hollow part 21 (recessed part). Further, in the embodiment, the shape of the hollow part 21 in the plan view from the perpendicular direction with respect to the principal surface 2a is a rectangular shape, but not limited to that.

Further, groove parts 22, 23, 24 are provided on the principal surface 2a of the substrate 2 outside the above described hollow part 21. The groove parts 22, 23, 24 have shapes corresponding to the wiring part 4 in the plan view from the perpendicular direction with respect to the principal surface 2a.

As a material forming the substrate 2, for example, a material of silicon, glass, or the like is preferably used. For example, when the device part 3 is formed using silicon as a major material, it is more preferable to use borosilicate glass for the substrate 2.

Note that it is preferable that a difference in coefficient of linear expansion between the constituent material of the substrate 2 and the constituent material of the device part 3 is small. For example, borosilicate glass is used for the substrate 2 and silicon is used for the device part 3, and thereby, the difference in coefficient of linear expansion between the substrate 2 and the device part 3 is smaller and distortion due to thermal expansion may be suppressed.

### Device Part 3

The device part 3 includes a first fixed part 31, a second fixed part 32, the movable part 33, the first beam part 34, and the second beam part 35. Further, the device part 3 includes the movable electrode parts 36, 37, the fixed electrode parts 38, 39, and stopper parts 60.

In the device part 3, the movable part 33 may be displaced in directions of an arrow a shown in FIG. 1, i.e., in the X-axis direction (+X-axis direction or −X-axis direction) while the first beam part 34 and the second beam part 35 are elastically deformed in response to a change of a physical quantity of acceleration, an angular velocity, or the like, for example.

In the device part 3, the gap d1 between the movable electrode part 36 and the fixed electrode part 38 and the gap d1 between the movable electrode part 37 and the fixed electrode part 39 respectively change with the above described displacement. In the device part 3, magnitudes of capacitances between the movable electrode part 36 and the fixed electrode part 38 and between the movable electrode part 37 and the fixed electrode part 39 respectively change with the above described changes of the gaps d1.

The functional device 1 may convert the physical quantity of acceleration, an angular velocity, or the like into electrical signals based on the changes of the capacitances.

### First Fixed Part 31, Second Fixed Part 32

The first fixed part 31 and the second fixed part 32 are respectively provided on the above described principal surface 2a of the substrate 2.

Specifically, the first fixed part 31 is provided on the principal surface 2a at the side in the −X-axis direction with respect to the hollow part 21. Further, the second fixed part 32 is provided on the principal surface 2a at the side in the +X-axis direction with respect to the hollow part 21. Furthermore, the first fixed part 31 and the second fixed part 32 are respectively provided along the outer peripheral edge of the hollow part 21 in the plan view from the perpendicular direction with respect to the principal surface 2a.

The first fixed part 31 has a fixed part 311 and a fixed part 312 to which the first beam part 34 is connected. The second fixed part 32 has a fixed part 321 and a fixed part 322 to which the second beam part 35 is connected.

### Movable Part 33, First Beam Part 34, Second Beam Part 35

As shown in FIG. 1, the movable part 33 is provided between the first fixed part 31 and the second fixed part 32. In the functional device 1, the movable part 33 has a longitudinal shape extending in the X-axis directions shown in FIG. 1. Note that the shape of the movable part 33 is determined according to the shapes, sizes, etc. of the respective parts forming the device part 3, but not limited to the above described shape.

The movable part 33 is coupled to the first fixed part 31 via the first beam part 34 and coupled to the second fixed part 32 via the second beam part 35. More specifically, the movable part 33 is coupled to the fixed part 311 via a projecting part 33L projecting toward the side in the −X-axis direction and a beam part 341 and coupled to the fixed part 312 via a beam part 342. Further, a projecting part 33R of the movable part 33 projecting toward the side in the +X-axis direction is coupled to the fixed part 321 via a beam part 351 and coupled to the fixed part 322 via a beam part 352.

The first beam part 34 includes the beam part 341 and the beam part 342. The beam part 341 and the beam part 342 respectively have shapes extending in the X-axis direction while meandering in the Y-axis direction.

The second beam part 35 includes the beam part 351 and the beam part 352. The beam part 351 and the beam part 352 respectively have shapes extending in the X-axis direction while meandering in the Y-axis direction.

In the embodiment, the first beam part 34 and the second beam part 35 are adapted to involve elastic deformation so that the movable part 33 may be displaced (movable) in the +X-axis direction and the −X-axis direction in which the first axis shown by the arrow a extends in FIG. 1.

The first fixed part 31 includes the fixed part 311 and the fixed part 312 and is provided on the principal surface 2a in the −X-axis direction as the extension direction of the first axis in which the movable part 33 is displaced. To the fixed part 311 and the fixed part 312, the beam part 341 and the beam part 342 extended from the movable part 33 are connected, respectively.

The second fixed part 32 includes the fixed part 321 and the fixed part 322 and is provided on the principal surface 2a in the +X-axis direction as the extension direction of the first axis in which the movable part 33 is displaced. To the fixed part 321 and the fixed part 322, the beam part 351 and the beam part 352 extended from the movable part 33 are connected, respectively.

The first beam part 34 and the second beam part 35 are connected to the first fixed part 31 and the second fixed part 32, and thereby, the movable part 33 is coupled (fixed) to the substrate 2.

### Movable Electrode Parts 36, 37

The movable electrode part 36 is extended from the movable part 33 in the +Y-axis direction as a second direction orthogonal to the X-axis direction as a first direction in which the movable part 33 is displaced. A plurality of the movable electrode parts 36 are provided to project from the movable part 33 in the +Y-axis direction in parallel to form a comb-like shape.

Further, the movable electrode part 37 is extended from the movable part 33 in the −Y-axis direction opposite to the +Y-axis direction in which the movable electrode part 36 is provided. A plurality of the movable electrode parts 37 are provided to project from the movable part 33 in the −Y-axis direction in parallel to form a comb-like shape.

As described above, the movable electrode parts 36 and the movable electrode parts 37 are provided in parallel in the X-axis direction as the first direction in which the movable part 33 is displaced (the directions of the arrow a shown in FIG. 1). In other words, the plurality of movable electrode parts 36 and movable electrode parts 37 are provided in parallel along the X-axis direction as the direction in which the movable part 33 is displaced to extend to both sides in the Y-axis direction crossing the displacement direction.

Thereby, the capacitances generated between the fixed electrode parts 38, 39 and the movable electrode parts 36, 37 to be described later may be changed in response to the displacement of the movable part 33.

### Fixed Electrode Parts 38, 39

The fixed electrode parts 38 are provided to form a comb-like shape meshing with the above described movable electrode parts 36.

The fixed electrode part 38 includes a fixed electrode 381 as a first fixed electrode and a fixed electrode 382 as a second fixed electrode. The fixed electrodes 381, 382 are provided to respectively have the gaps d1 between the movable electrode parts 36 and themselves. Note that the explanation will be made with the reference of the fixed electrode part 38 including the fixed electrodes 381, 382.

The fixed electrode parts 39 are provided to form a comb-like shape meshing with the movable electrode parts 37 like the above described fixed electrode part 38. The fixed electrode part 39 includes a fixed electrode 391 as a third fixed electrode and a fixed electrode 392 as a fourth fixed electrode. The fixed electrodes 391, 392 are provided to respectively have the gaps d1 between the movable electrode parts 37 and themselves. Note that the explanation will be made with the reference of the fixed electrode part 39 including the fixed electrodes 391, 392.

The fixed electrode parts 38 (fixed electrodes 381, 382) are provided at the side in the +Y-axis direction with respect to the movable part 33. Ends of the fixed electrode parts 38 in the +Y-axis direction are connected to the wiring part 4 provided on the principal surface 2a, and extended in the −Y-axis direction with the connected one ends as fixed ends and one ends at the opposite side to the fixed ends as free ends.

The fixed electrode parts 39 (fixed electrodes 391, 392) are provided at the side in the −Y-axis direction with respect to the movable part 33. Ends of the fixed electrode parts 39 in the −Y-axis direction are connected to the wiring part 4 provided on the principal surface 2a, and extended in the +Y-axis direction with the connected one ends as fixed ends and one ends at the opposite side to the fixed ends as free ends.

### Stopper Parts 60

The stopper parts 60 that regulate the displacement of the movable part 33 are provided in the functional device 1 of the embodiment.

The stopper parts 60 are respectively provided on the principal surface 2a to be opposed to the projecting part 33L and the projecting part 33R extended from the movable part 33. Specifically, the stopper part 60L is provided to be opposed to the projecting part 33L of the movable part 33 in the −X-axis direction in the extension direction of the first axis in which the movable part 33 is displaced. Further, the stopper part 60R is provided to be opposed to the projecting part 33R of the movable part 33 in the +X-axis direction in the extension direction of the first axis in which the movable part 33 is displaced.

Here, the arrangement etc. of the movable part 33 and the stopper parts 60 are described in detail.

The stopper parts 60 are provided to suppress breakage due to contact with each other between the movable electrode parts 36 and the fixed electrode parts 38 and between the movable electrode parts 37 and the fixed electrode parts 39 arranged side by side when the movable part 33 is excessively displaced. Further, the stopper parts 60 are provided to suppress sticking or short-circuit caused by the contact with each other between the movable electrode parts 36 and the fixed electrode parts 38 and between the movable electrode parts 37 and the fixed electrode parts 39.

In the movable part 33, the projecting part 33L is extended between the beam part 341 and the beam part 342 and toward the stopper part 60L provided in the direction in which the first axis extends (−X-axis direction) as shown in FIG. 1. The extended projecting part 33L is provided to have a gap d2 between the projecting part 33L and the stopper part 60L.

Further, in the movable part 33, the projecting part 33R is extended between the beam part 351 and the beam part 352 and toward the stopper part 60R provided in the direction in which the first axis extends (+X-axis direction) as shown in FIG. 1. The extended projecting part 33R is provided to have a gap d2 between the projecting part 33R and the stopper part 60R.

For the functional device 1 in the first embodiment, when the movable part 33 is excessively displaced, contact between the stopper parts 60 and the movable part 33 is desired before contact between the fixed electrode parts 38, 39 and the movable electrode parts 36, 37. Thus, in the functional device 1, the movable part 33 is provided so that the gaps d2 between the movable part 33 (projecting part 33L, projecting part 33R) and the stopper parts 60 may be narrower than the gaps d1 between the movable electrode parts 36, 37 and the fixed electrode parts 38, 39. That is, the movable part 33 (projecting part 33L, projecting part 33R) is extended toward the stopper parts 60 so that the width relationship between the gaps d1 and the gaps d2 may satisfy gap d1>gap d2.

Further, in the functional device 1, when the movable part 33 is displaced in the rotation direction around the point P shown in FIG. 1, the projecting part 33L comes into contact with the first beam part 34 (beam part 341, beam part 342), and thereby, displacement in the rotation direction generated in the movable part 33 may be regulated. Furthermore, the projecting part 33R comes into contact with the second beam part 35 (beam part 351, beam part 352), and thereby, displacement in the rotation direction generated in the movable part 33 may be regulated.

Further, in the functional device 1, the first beam part 34 (beam part 341, beam part 342) and the second beam part 35 (beam part 351, beam part 352) are coupled to the first, second fixed parts 31, 32 with gaps, and thereby, the movable part 33 is fixed. Therefore, the displacement of the movable part 33 in the rotation direction around the point P shown in FIG. 1 may be suppressed.

Thereby, the functional device 1 may suppress excessive displacement of the movable part 33 by the contact between the movable part 33 and the stopper parts 60 before the contact between the fixed electrode parts 38, 39 and the movable electrode parts 36, 37. Further, when the movable part 33 is displaced in an in-plane rotation direction, the displacement in the rotation direction may be regulated by the contact between the projecting part 33L and the projecting part 33R, and the first beam part 34 and the second beam part 35. Furthermore, the movable part 33 may suppress the displacement in the rotation direction generated in the movable part 33 by urging forces of the beam part 341 and the beam part 342 extended from the projecting part 33L and the beam part 351 and the beam part 352 extended from the projecting part 33R.

In addition, it is preferable that the stopper parts 60 are at the same potential (equal potential) with the movable part 33.

The stopper parts 60 are at the equal potential to the movable part 33, and thereby, when coming into contact with the movable part 33, no electrostatic force acts thereon and sticking may be suppressed. Further, the stopper parts are at the equal potential to the movable part 33, and thereby, fluctuations and losses due to ground faults of capacitances caused between the movable electrode parts 36, 37 and the fixed electrode parts 38, 39 may be suppressed.

For the purpose, the stopper parts 60 are electrically connected to the movable part 33 via the first fixed part 31 and the first beam part 34, and the second fixed part 32 and the second beam part 35 by wiring (not shown).

As a material forming the device part 3, not particularly limited, but any material having conductivity may be used. For example, a silicon substrate is preferably used for the material forming the device part 3. Using the silicon substrate, the first fixed part 31, the second fixed part 32, the movable part 33, the first beam part 34 and the second beam part 35, the movable electrode parts 36, 37, the fixed electrode parts 38, 39, and the stopper parts 60 may be integrally formed using a typical semiconductor device manufacturing technology.

### Wiring Part 4

The wiring part 4 is provided on the principal surface 2a of the substrate 2. The wiring part 4 includes wires 41, 42, 43 and electrodes 44, 45, 46.

The wire 41 is provided on the principal surface 2a between the hollow part 21 and the outer peripheral edge of the substrate 2 along the outer periphery of the hollow part 21. One end of the wire 41 is connected to the electrode 44. Further, the other end of the wire 41 different from the one end connected to the electrode 44 is electrically connected to the fixed electrodes 381 as the first fixed electrodes and the fixed electrodes 391 as the third fixed electrodes of the plurality of fixed electrode parts 38, 39.

The wire 42 is provided on the principal surface 2a between the hollow part 21 and the outer peripheral edge of the substrate 2 along the wire 41. One end of the wire 42 is connected to the electrode 45.

Further, the other end of the wire 42 different from the one end connected to the electrode 45 is electrically connected to the fixed electrodes 382 as the second fixed electrodes and the fixed electrodes 392 as the fourth fixed electrodes of the plurality of fixed electrode parts 38, 39.

The wire 43 is connected to the first fixed part 31 (fixed part 311, fixed part 312) and the electrode 46 is connected to the other end of the wire 43 different from the one end connected to the first fixed part 31.

Further, the wire 41 is provided within the groove 22 (recessed part) provided on the principal surface 2a. The wire 42 is provided within the groove 23 (recessed part) provided on the principal surface 2a. The wire 43 is provided within the groove 24 (recessed part) provided on the principal surface 2a.

As materials forming the wires 41 to 43, not particularly limited, but any materials having conductivity may be used. For example, the materials include ITO (Indium Tin Oxide), IZO (Indium Zinc Oxide), gold (Au), platinum (Pt), silver (Ag), copper (Cu), aluminum (Al), or alloys containing them, and one of them or a combination of some of them may be used.

Further, as materials forming the electrodes 44 to 46, like the above described wires 41 to 43, not particularly limited, but any materials having conductivity may be used.

By the wire 41 and the electrode 44, and the wire 43 and the electrode 46, changes of the capacitances between the first fixed electrodes (fixed electrodes 381) and the movable electrode parts 36 and the capacitances between the third fixed electrodes (fixed electrodes 391) and the movable electrode parts 37 may be output via the wire 41.

Further, by the wire 42 and the electrode 45, and the wire 43 and the electrode 46, changes of the capacitances between the second fixed electrodes (fixed electrodes 382) and the movable electrode parts 36 and the capacitances between the fourth fixed electrodes (fixed electrodes 392) and the movable electrode parts 37 may be output via the wire 42.

### Lid Member

The lid member (not shown) is provided for protection of the above described device part 3.

The lid member has a plate shape and a cavity (not shown) is provided on one surface (lower surface) thereof. The cavity is formed to allow the displacement of the movable part 33.

Further, the part outer than the cavity on the lower surface of the lid member is connected to the above described principal surface 2a (substrate 2).

As a connecting method for the lid member and the substrate 2, not particularly limited, but, for example, a connecting method using an adhesive, an anodic bonding (connecting) method, or the like may be used.

Further, as a material forming the lid member, not particularly limited, but a material suitable for the connecting method may be used. For example, a silicon material may be used for the connection using an adhesive and a glass material or the like may be used for the connection using the anodic bonding method.

According to the above described first embodiment, the following advantages may be obtained.

According to the functional device 1, when the movable part 33 is displaced in the direction in which the first axis extends, the movable part 33 and the stopper parts 60 come into contact before contact between the movable electrode parts 36, 37 and the fixed electrode parts 38, 39, and thereby, the contact between the fixed electrode parts 38, 39 and the movable electrode parts 36, 37 may be suppressed. Further, when the displacement in the rotation direction around the point P in the plan view from the perpendicular direction with respect to the movable part 33 is generated in the movable part 33, the projecting part 33L and the projecting part 33R come into contact with the first beam part 34 and the second beam part 35, and thereby, the displacement may be regulated.

Thus, when a force of acceleration or the like is applied to the functional device 1 and the movable part 33 is excessively displaced, by the contact between the fixed electrode parts 38, 39 and the movable electrode parts 36, 37 or the like, sticking and breakage of the electrode parts may be suppressed. Further, the functional device 1 that may suppress losses of the capacitances generated between the fixed electrode parts 38, 39 and the movable electrode parts 36, 37 and may continuously measure the physical quantity of acceleration or the like may be obtained.

### Second Embodiment

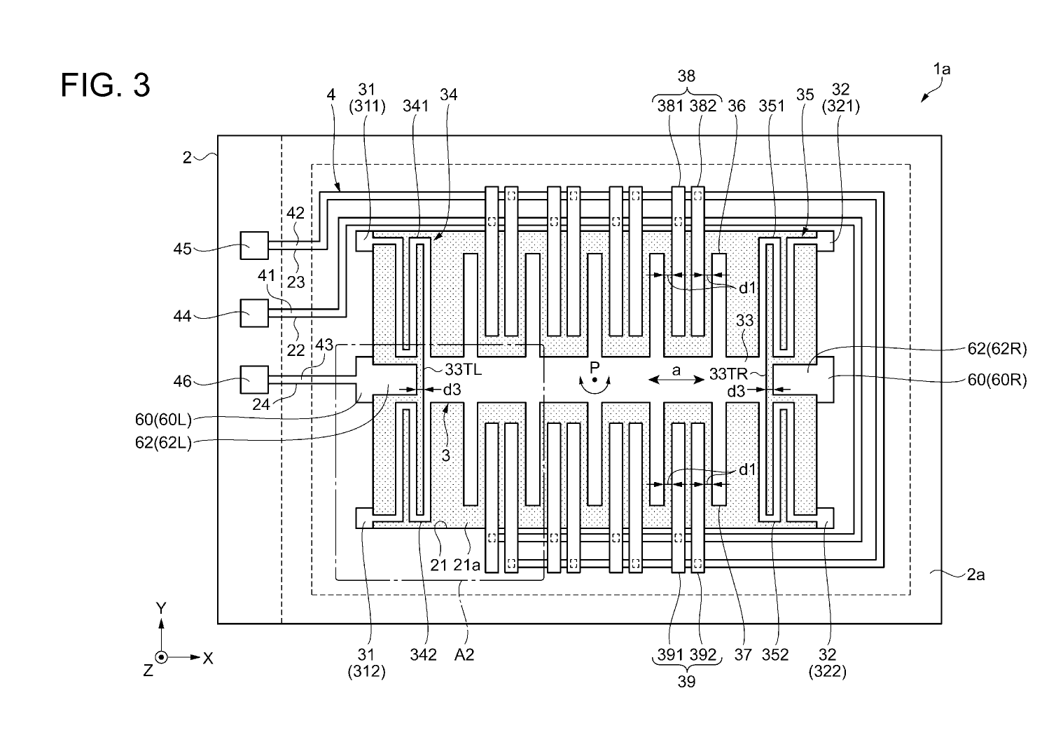

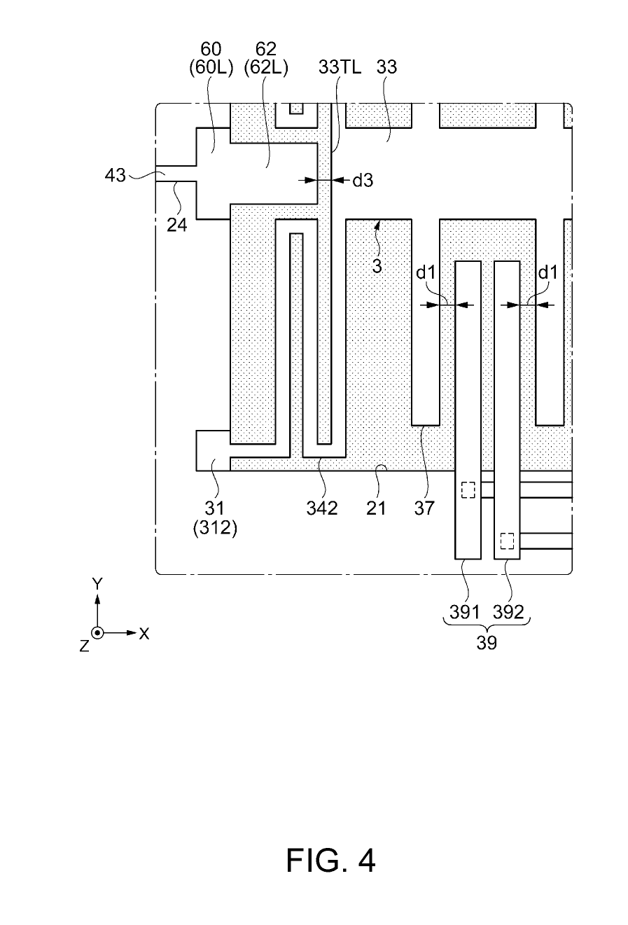

A functional device according to the second embodiment will be explained using FIGS. 3 and 4.

FIG. 3 is a plan view showing an outline of the functional device according to the second embodiment. FIG. 4 is an enlarged schematic diagram of a part shown by a dashed-dotted line A2 in FIG. 3. For convenience of explanation, illustration of a lid member is omitted in FIGS. 3 and 4. Further, in FIGS. 3 and 4, an X-axis, a Y-axis, and a Z-axis are shown as three axes orthogonal to one another, and the Z-axis is an axis indicating a thickness direction in which a substrate and a device part overlap.

A functional device 1a according to the second embodiment is different from the functional device 1 explained in the first embodiment in that the stopper parts 60 are extended toward the movable part 33.

The other configurations etc. are nearly the same as those of the above described functional device 1 in the first embodiment, and the functional device 1a will be explained with the same configurations having the same signs and numerals and their explanation will be partially omitted.

### Structure of Functional Device 1a

The functional device 1a of the embodiment shown in FIGS. 3 and 4 includes a substrate 2, a device part 3 provided on the substrate 2, and a wiring part 4 electrically connected to the device part 3 like the above described functional device 1 in the first embodiment.

In the functional device 1a, a movable part 33 forming the device part 3 can move due to acceleration or the like applied to the functional device 1a, and thereby, gaps d1 between fixed electrode parts 38, 39 provided on the substrate 2 and movable electrode parts 36, 37 provided on the movable part 33 change. The acceleration or the like applied to the functional device 1a is measured according to the changes of the gaps d1.

### Movable Part 33

In the functional device 1a, the movable part 33 is extended in the X-axis direction as an extension direction of a first axis in which the movable part 33 is displaced. A first beam part 34 is connected to an end part 33TL of the movable part 33 at the side in the −X-axis direction as the direction in which the first axis extends. Further, a second beam part 35 is connected to an end part 33TR of the movable part 33 at the side in the +X-axis direction as the direction in which the first axis extends.

The movable part 33 is coupled to a first fixed part 31 via a first beam part 34 and coupled to a second fixed part 32 via a second beam part 35. More specifically, the end part 33TL of the movable part 33 at the side in the −X-axis direction is coupled to a fixed part 311 via a beam part 341 and coupled to a fixed part 312 via a beam part 342. Further, the end part 33TR of the movable part 33 at the side in the +X-axis direction is connected to a fixed part 321 via a beam part 351 and connected to a fixed part 322 via a beam part 352.

### Stopper Parts 60

The stopper parts 60 that regulate the displacement of the movable part 33 are provided in the functional device 1a of the embodiment. Further, projecting parts 62 are extended from the stopper parts 60 toward the movable part 33.

The stopper parts 60 are respectively provided on the principal surface 2a to be opposed to the end parts 33TL, 33TR of the movable part 33. Specifically, a stopper part 60L and a projecting part 62L are provided to be opposed to the end part 33TL of the movable part 33 in the −X-axis direction as the extension direction of the first axis in which the movable part 33 is displaced. The projecting part 62L extended from the stopper part 60L is extended toward the end part 33TL of the movable part 33 between the beam part 341 and the beam part 342. Further, a stopper part 60R and a projecting part 62R are provided to be opposed to the end part 33TR of the movable part 33 in the +X-axis direction as the extension direction of the first axis in which the movable part 33 is displaced. The projecting part 62R extended from the stopper part 60R is extended toward the end part 33TR of the movable part 33 between the beam part 351 and the beam part 352.

Here, the arrangement etc. of the movable part 33 and the stopper parts 60 are described in detail.

The stopper parts 60 are provided, like in the functional device 1, to suppress breakage of the movable electrode parts 36 and the fixed electrode parts 38, and the movable electrode parts 37 and the fixed electrode parts 39 arranged side by side due to contact with each other when the movable part 33 is excessively displaced.

Further, the stopper parts 60 are provided to suppress sticking or short-circuit caused by the contact with each other between the movable electrode parts 36 and the fixed electrode parts 38 and between the movable electrode parts 37 and the fixed electrode parts 39.

For the functional device 1a in the second embodiment, when excessive displacement is applied to the movable part 33, contact between the stopper parts 60 and the movable part 33 is desired before contact between the fixed electrode parts 38, 39 and the movable electrode parts 36, 37.

Thus, the stopper parts 60 are provided so that gaps d3 between the movable part 33 (end parts 33TL, 33TR) and the stopper parts 60 (projecting parts 62L, 62R) may be narrower than the gaps d1 between the movable electrode parts 36, 37 and the fixed electrode parts 38, 39. That is, the stopper parts 60 (projecting parts 62) are extended toward the movable part 33 so that the width relationship between the gaps d1 and the gaps d3 may satisfy gap d1>gap d3.

Further, in the functional device 1a, when the movable part 33 is displaced in the rotation direction around the point P shown in FIG. 3, for example, the stopper part 60L (projecting part 62L) comes into contact with the first beam part 34 (beam part 341, beam part 342), and thereby, displacement in the rotation direction generated in the movable part 33 may be regulated. Furthermore, the stopper part 60R (projecting part 62R) comes into contact with the second beam part 35 (beam part 351, beam part 352), and thereby, displacement in the rotation direction generated in the movable part 33 may be regulated.

Thereby, the functional device 1a may suppress excessive displacement of the movable part 33 by the contact between the movable part 33 and the stopper parts 60 before the contact between the fixed electrode parts 38, 39 and the movable electrode parts 36, 37. Further, when the movable part 33 rotates in the rotation direction, the displacement in the rotation direction may be regulated by the contact between the stopper parts 60L, 60R (projecting parts 62L, 62R), and the first beam part 34 and the second beam part 35. Furthermore, the movable part 33 may suppress the displacement in the rotation direction generated in the movable part 33 by urging forces of the beam part 341 and the beam part 342 extended from the end part 33TL and the beam part 351 and the beam part 352 extended from the end part 33TR.

In the functional device 1a, the other configurations are the same as those of the above described functional device 1 in the first embodiment, and their explanation will be omitted.

According to the above described second embodiment, the following advantages may be obtained.

According to the functional device 1a, when the movable part 33 is displaced in the first direction, the movable part 33 and the stopper parts 60 come into contact before contact between the movable electrode parts 36, 37 and the fixed electrode parts 38, 39, and thereby, the contact between the fixed electrode parts 38, 39 and the movable electrode parts 36, 37 may be suppressed. Further, when displacement in the rotation direction around the point P in the plan view from the perpendicular direction with respect to the movable part 33 is generated in the movable part 33, the stopper parts 60 come into contact with the first beam part 34 and the second beam part 35, and thereby, the displacement may be regulated.

Thus, when a force of acceleration or the like is applied to the functional device 1a and the movable part 33 is excessively displaced, by the contact between the fixed electrode parts 38, 39 and the movable electrode parts 36, 37 or the like, sticking and breakage of the electrode parts may be suppressed. Further, the functional device 1a that may suppress losses of the capacitances generated between the fixed electrode parts 38, 39 and the movable electrode parts 36, 37 and may continuously measure the physical quantity of acceleration or the like may be obtained.

### Third Embodiment

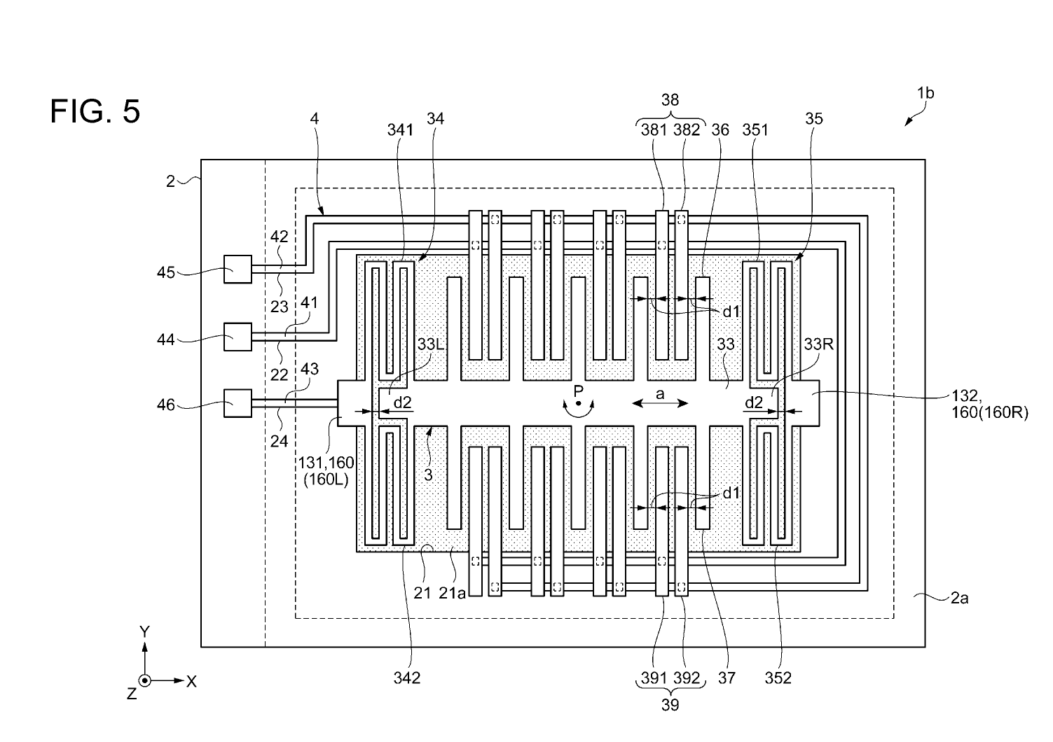

A functional device according to the third embodiment will be explained using FIG. 5.

FIG. 5 is a plan view showing an outline of the functional device according to the third embodiment. For convenience of explanation, illustration of a lid member is omitted in FIG. 5. Further, in FIG. 5, an X-axis, a Y-axis, and a Z-axis are shown as three axes orthogonal to one another, and the Z-axis is an axis indicating a thickness direction in which a substrate and a device part overlap.

A functional device 1b according to the third embodiment is different from the functional device 1 explained in the first embodiment in that fixed parts 131, 132 and stopper parts 160 are integrally provided.

The other configurations etc. are nearly the same as those of the above described functional device 1 in the first embodiment, and the functional device 1b will be explained with the same configurations having the same signs and numerals and their explanation will be partially omitted.

### Structure of Functional Device 1b

The functional device 1b of the embodiment shown in FIG. 5 includes a substrate 2, a device part 3 provided on the substrate 2, and a wiring part 4 electrically connected to the device part 3 like the above described functional device 1 in the first embodiment.

In the functional device 1b, a movable part 33 forming the device part 3 can move due to acceleration or the like applied to the functional device 1b, and thereby, gaps d1 between fixed electrode parts 38, 39 provided on the substrate 2 and movable electrode parts 36, 37 provided on the movable part 33 change. The acceleration or the like applied to the functional device 1b is measured according to the changes of the gaps d1.

### Movable Part 33

In the functional device 1b, the movable part 33 is extended in the X-axis direction as an extension direction of a first axis in which the movable part 33 is displaced. A first beam part 34 is connected to a projecting part 33L provided in the −X-axis direction as the direction in which the first axis extends. Further, a second beam part 35 is connected to a projecting part 33R provided in the +X-axis direction as the direction in which the first axis extends.

The projecting part 33L (movable part 33) is connected to one end of the first beam part 34 and the other end of the first beam part 34 is connected to a fixed part 131. Further, the projecting part 33R (movable part 33) is connected to one end of the second beam part 35 and the other end of the second beam part 35 is connected to a fixed part 132. Thereby, the movable part 33 is fixed to the substrate 2.

More specifically, the movable part 33 is coupled to the fixed part 131 via the projecting part 33L projecting to the side in the −X-axis direction. Further, the movable part 33 is coupled to the fixed part 132 via the projecting part 33R projecting to the side in the +X-axis direction.

### Fixed Parts 131, 132, Stopper Parts 160

As shown in FIG. 5, the fixed part 131 is provided integrally with a stopper part 160L. Further, the fixed part 132 is provided integrally with a stopper part 160R.

The fixed part 131 is provided on the principal surface 2a in the −X-axis direction as one direction of the extension directions of the first axis in which the movable part 33 is displaced. To the fixed part 311, beam parts 341, 342 extended from the projecting part 33L are connected. The fixed part 132 is provided on the principal surface 2a in the +X-axis direction as one direction of the extension directions of the first axis in which the movable part 33 is displaced. To the fixed part 132, beam parts 351, 352 extended from the projecting part 33R are connected.

The first beam part 34 and the second beam part 35 are connected to the fixed parts 131, 132, respectively, and thereby, the movable part 33 may be fixed to the substrate 2.

Here, the arrangement etc. of the movable part 33 and the stopper parts 160 are described in detail.

The stopper parts 160 are provided to suppress breakage due to contact with each other between the movable electrode parts 36 and the fixed electrode parts 38 and between the movable electrode parts 37 and the fixed electrode parts 39 arranged side by side when the movable part 33 is excessively displaced. Further, the stopper parts 160 are provided to suppress sticking or short-circuit caused by the contact with each other between the movable electrode parts 36 and the fixed electrode parts 38 and between the movable electrode parts 37 and the fixed electrode parts 39.

In the movable part 33, the projecting part 33L is extended between a beam part 341 and a beam part 342 and toward the stopper part 160L provided in the direction in which the first axis extends (−X-axis direction) as shown in FIG. 5. The movable part 33 is provided to have a gap d2 between the extended projecting part 33L and the stopper part 160L. Further, in the movable part 33, the projecting part 33R is extended between a beam part 351 and a beam part 352 and toward the stopper part 160R provided in the direction in which the first axis extends (+X-axis direction) as shown in FIG. 5. The movable part 33 is provided to have a gap d2 between the extended projecting part 33R and the stopper part 160R.

For the functional device 1b in the third embodiment, when excessive displacement is applied to the movable part 33, contact between the stopper parts 160 and the movable part 33 is desired before contact between the fixed electrode parts 38, 39 and the movable electrode parts 36, 37.

Thus, the movable part 33 is provided so that the gaps d2 between the movable part 33 (projecting part 33L, projecting part 33R) and the stopper parts 160 may be narrower than the gaps d1 between the movable electrode parts 36, 37 and the fixed electrode parts 38, 39. That is, the movable part 33 (projecting part 33L, projecting part 33R) is extended toward the stopper parts 160 so that the width relationship between the gaps d1 and the gaps d2 may satisfy gap d1>gap d2.

Thereby, in the functional device 1b, the stopper parts 160 and the movable part 33 come into contact before contact between the fixed electrode parts 38, 39 and the movable electrode parts 36, 37, and excessive displacement of the movable part 33 may be regulated. Further, when the movable part 33 is displaced in the rotation direction around the point P, the projecting parts 33L, 33R come into contact with the first beam part 34 and the second beam part 35, and thereby, displacement in the rotation direction may be regulated.

In the functional device 1b, the other configurations are the same as those of the above described functional device 1 in the first embodiment, and their explanation will be omitted.

According to the above described third embodiment, the following advantages may be obtained.

According to the functional device 1b, when the movable part 33 is displaced in the first direction, the movable part 33 and the stopper parts 160 come into contact before contact between the movable electrode parts 36, 37 and the fixed electrode parts 38, 39, and thereby, the contact between the fixed electrode parts 38, 39 and the movable electrode parts 36, 37 may be suppressed. Further, when displacement in the rotation direction around the point P in the plan view from the perpendicular direction with respect to the movable part 33 is generated in the movable part 33, the projecting parts 33L, 33R of the movable part 33 come into contact with the first beam part 34 and the second beam part 35, and thereby, the displacement may be regulated.

Thus, when a force of acceleration or the like is applied to the functional device 1b and the movable part 33 is excessively displaced, by the contact between the fixed electrode parts 38, 39 and the movable electrode parts 36, 37 or the like, sticking and breakage of the electrode parts may be suppressed. Further, the functional device 1b that may suppress losses of the capacitances generated between the fixed electrode parts 38, 39 and the movable electrode parts 36, 37 and may continuously measure the physical quantity of acceleration or the like may be obtained.

### Fourth Embodiment

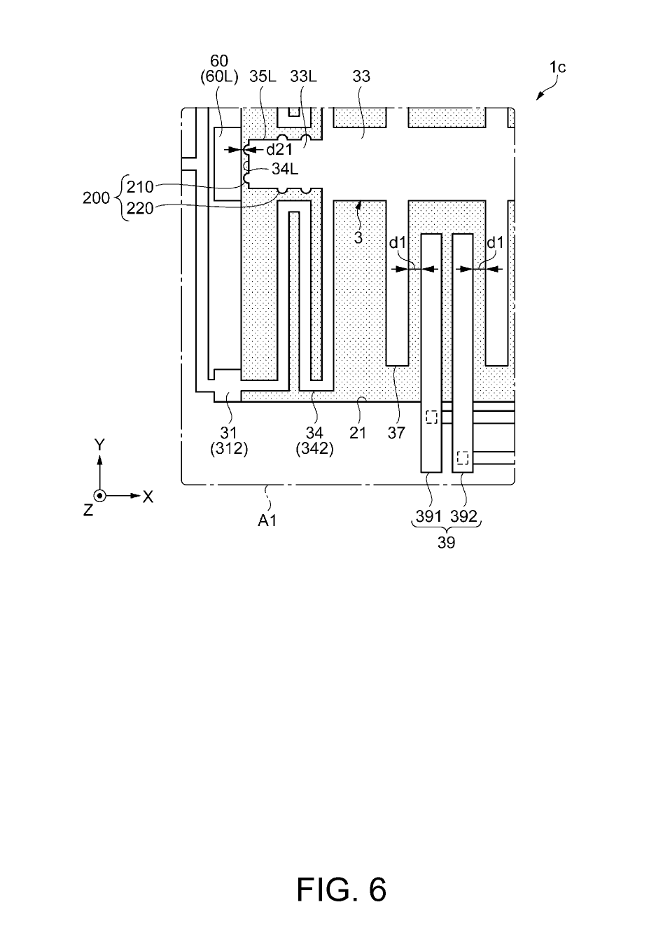

A functional device according to the fourth embodiment will be explained using FIG. 6.

FIG. 6 is an enlarged schematic diagram showing a part of the functional device according to the fourth embodiment and corresponds to the part of the dashed-dotted line A1 in FIG. 1 showing the above described functional device 1 in the first embodiment. In FIG. 6, an X-axis, a Y-axis, and a Z-axis are shown as three axes orthogonal to one another, and the Z-axis is an axis indicating a thickness direction in which a substrate and a device part overlap.

A functional device 1c according to the fourth embodiment is different from the functional device 1 explained in the first embodiment in that projections 200 are provided on the projecting parts 33L and 33R of the movable part 33.

The other configurations etc. are nearly the same as those of the above described functional device 1 in the first embodiment, and the functional device 1c will be explained with the same configurations having the same signs and numerals and their explanation will be partially omitted.

### Structure of Functional Device 1c

The functional device 1c of the embodiment shown in FIG. 6 includes a substrate 2, a device part 3 provided on the substrate 2, and a wiring part 4 electrically connected to the device part 3 like the above described functional device 1 in the first embodiment.

In the functional device 1c, a movable part 33 forming the device part 3 can move due to acceleration or the like applied to the functional device 1c, and thereby, gaps d1 between fixed electrode parts 38, 39 provided on the substrate 2 and movable electrode parts 36, 37 provided on the movable part 33 change. The acceleration or the like applied to the functional device 1c is measured according to the changes of the gaps d1.

### Movable Part 33

In the functional device 1c, the movable part 33 is extended in the X-axis direction as a first direction in which the movable part 33 is displaced. A first beam part 34 is connected to a projecting part 33L provided in the −X-axis direction as the direction in which a first axis extends. Further, a second beam part 35 is connected to a projecting part 33R provided in the +X-axis direction as the direction in which the first axis extends.

Furthermore, the projections 200 are provided on the projecting part 33L of the movable part 33. Projections 210 are provided on an end surface 34L of the projecting part 33L opposed to the stopper part 60L and projections 220 are provided on an end surface 35L of the projecting part 33L in the direction crossing the end surface 34L.

In addition, though not illustrated, the projections 200 are similarly provided on the projecting part 33R opposite to the projecting part 33L.

### Stopper Parts 60

The stopper parts 60 that regulate the displacement of the movable part 33 are provided in the functional device 1c of the embodiment like in the functional device 1.

The stopper parts 60 are respectively provided on the principal surface 2a to be opposed to the projecting parts 33L, 33R of the movable part 33.

Here, the arrangement etc. of the movable part 33 and the stopper parts 60 are described in detail.

The stopper parts 60 are provided to suppress breakage due to contact with each other between the movable electrode parts 36 and the fixed electrode parts 38 and between the movable electrode parts 37 and the fixed electrode parts 39 arranged side by side when the movable part 33 is excessively displaced. Further, the stopper parts 60 are provided to suppress sticking or short-circuit caused by the contact with each other between the movable electrode parts 36 and the fixed electrode parts 38 and between the movable electrode parts 37 and the fixed electrode parts 39.

In the movable part 33, the projecting part 33L is extended between the beam part 341 and the beam part 342 and toward the stopper part 60L provided in the direction in which the first axis extends (−X-axis direction) as shown in the partially enlarged view in FIG. 6. The movable part 33 is provided to have a gap d21 between the projections 210 provided on the end surface 34L of the extended projecting part 33L and the stopper part 60L. Further, in the movable part 33, the projecting part 33R (not shown) is extended between the beam part 351 and the beam part 352 and toward the stopper part 60R (not shown) provided in the direction in which the first axis extends (+X-axis direction). The movable part 33 is provided to have a gap d21 between the projections 210 provided on the end surface 34R (not shown) of the extended projecting part 33R and the stopper part 60R.

For the functional device 1c in the fourth embodiment, when excessive displacement is applied to the movable part 33, contact between the stopper parts 60 and the projections 200 of the movable part 33 is desired before contact between the fixed electrode parts 38, 39 and the movable electrode parts 36, 37.

Thus, the movable part 33 is provided so that the gaps d21 between the projections 200 provided on the movable part 33 and the stopper parts 60 may be narrower than the gaps d1 between the movable electrode parts 36, 37 and the fixed electrode parts 38, 39. That is, the projections 200 are provided on the movable part 33 (projecting part 33L, projecting part 33R) so that the width relationship between the gaps d1 and the gaps d21 may satisfy gap d1>gap d21.

Thereby, in the functional device 1c, the projections 210 provided on the movable part 33 and the stopper parts 60 come into contact before contact between the fixed electrode parts 38, 39 and the movable electrode parts 36, 37, and excessive displacement of the movable part 33 may be suppressed.

Further, when the movable part 33 is displaced in a second direction crossing the direction in which the first axis extends, the first beam part 34 and the second beam part 35 may be brought into point contact because the projections 220 are provided on the end surfaces 35L, 35R of the movable part 33. Therefore, sticking and breakage due to contact between the movable part 33 and the first beam part 34, the second beam part 35 may be suppressed.

In the functional device 1c, the other configurations are the same as those of the above described functional device 1 in the first embodiment, and their explanation will be omitted.

According to the above described fourth embodiment, the following advantages may be obtained.

According to the functional device 1c, the contact area when the stopper parts 60 and the movable part 33 come into contact may be made smaller compared to those of the above described functional devices 1, 1a, 1b.

Further, the projections 220 are provided on the end surfaces 35L, 35R of the projecting parts 33L, 33R opposed to the first beam part 34, the second beam part 35, and thereby, the contact area between the first beam part 34, the second beam part 35 and the projecting parts 33L, 33R may be made smaller. Therefore, sticking when the movable part 33 and the stopper parts 60 or the movable part 33 and the first beam part 34, the second beam part 35 come into contact may be suppressed. Further, the impact when the movable part 33 and the stopper parts 60 or the movable part 33 and the first beam part 34, the second beam part 35 come into contact may be reduced. Thus, breakage of the functional device 1c when the movable part 33 and the stopper parts 60 or the movable part 33 and the first beam part 34, the second beam part 35 come into contact may be suppressed.

### Fifth Embodiment

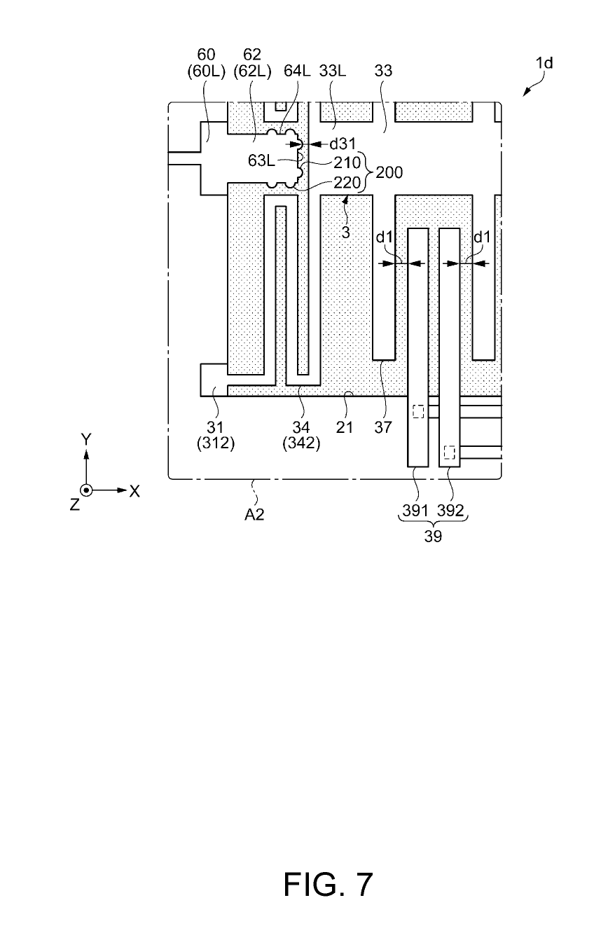

A functional device according to the fifth embodiment will be explained using FIG. 7.

FIG. 7 is an enlarged schematic diagram showing a part of the functional device according to the fifth embodiment and corresponds to the part of the dashed-dotted line A2 in FIG. 3 showing the above described functional device 1a in the second embodiment. In FIG. 7, an X-axis, a Y-axis, and a Z-axis are shown as three axes orthogonal to one another, and the Z-axis is an axis indicating a thickness direction in which a substrate and a device part overlap.

A functional device 1d according to the fifth embodiment is different from the functional device 1a explained in the second embodiment in that projections 200 are provided on the stopper parts 60.

The other configurations etc. are nearly the same as those of the above described functional device 1a in the second embodiment, and the functional device 1d will be explained with the same configurations having the same signs and numerals and their explanation will be partially omitted.

### Structure of Functional Device 1d

The functional device 1d of the embodiment shown in FIG. 7 includes a substrate 2, a device part 3 provided on the substrate 2, and a wiring part 4 electrically connected to the device part 3 like the above described functional device 1 in the first embodiment.

In the functional device 1d, a movable part 33 forming the device part 3 can move due to acceleration or the like applied to the functional device 1d, and thereby, gaps d1 between fixed electrode parts 38, 39 provided on the substrate 2 and movable electrode parts 36, 37 provided on the movable part 33 change. The acceleration or the like applied to the functional device 1d is measured according to the changes of the gaps d1.

### Movable Part 33

In the functional device 1d, the movable part 33 is extended in the X-axis direction as a first direction in which the movable part 33 is displaced. A first beam part 34 is connected to a projecting part 33L in the −X-axis direction as the first direction. Further, a second beam part 35 is connected to a projecting part 33R (not shown) in the +X-axis direction as the first direction.

### Stopper Parts 60

The stopper parts 60 that regulate the displacement of the movable part 33 are provided in the functional device 1d of the embodiment like in the functional device 1a. Further, projecting parts 62 are extended from the stopper parts 60 toward the movable part 33.

The stopper parts 60 include a stopper part 60L provided on a principal surface 2a to be opposed to an end part 33TL of the movable part 33 and a stopper part 60R (not shown) provided on the principal surface 2a to be opposed to an end part 33TR (not shown) of the movable part 33. As shown in FIG. 7, the stopper part 60L and a projecting part 62L from the stopper part 60L are extended to be opposed to the end part 33TL of the movable part 33 in the −X-axis direction. Like the stopper part 60L and the projecting part 62L, the stopper part 60R and a projecting part 62R from the stopper part 60R are extended to be opposed to the end part 33TR of the movable part 33 in the +X-axis direction.

The projections 200 are provided on the projecting part 62L (stopper part 60L) and the projecting part 62R (stopper part 60R) (not shown). In the projecting part 62L, projections 210 are provided on an end surface 63L opposed to the movable part 33 and projections 220 are provided on an end surface 64L of the projecting part 62L in the direction crossing the end surface 63L.

Further, also, in the projecting part 62R (stopper part 60R) (not shown) opposite to the projecting part 62L (stopper part 60L), the projections 210 (not shown) are provided on an end surface 63R (not shown) opposed to the movable part 33 and the projections 220 (not shown) are provided on an end surface 64R (not shown) of the stopper part 60R in the direction crossing the end surface 63R.

Here, the arrangement etc. of the movable part 33 and the stopper parts 60 are described in detail.

The stopper parts 60 are provided to suppress breakage due to contact with each other between the movable electrode parts 36 and the fixed electrode parts 38 and between the movable electrode parts 37 and the fixed electrode parts 39 arranged side by side when the movable part 33 is excessively displaced. Further, the stopper parts 60 are provided to suppress sticking or short-circuit caused by the contact with each other between the movable electrode parts 36 and the fixed electrode parts 38 and between the movable electrode parts 37 and the fixed electrode parts 39.

The stopper part 60L is extended between a beam part 341 and a beam part 342 and toward the movable part 33 provided in the direction in which the first axis extends (+X-axis direction) as shown in FIG. 7. In the stopper part 60L, the projections 210 are provided on the end surface 63L of the extended projecting part 62L. The projecting part 62L is provided to have a gap d31 between the projections 210 and the movable part 33. Further, the stopper part 60R is extended between a beam part 351 and a beam part 352 and toward the movable part 33 provided in the direction in which the first axis extends (−X-axis direction) like the stopper part 60L (see FIG. 3). In the stopper part 60R, the projections 210 are provided on the end surface 63R of the extended projecting part 62R. The projecting part 62R is provided to have the gap d31 between the projections 210 and the movable part 33.

For the functional device 1d in the fifth embodiment, when excessive displacement is applied to the movable part 33, contact between the movable part 33 and the projections 210 provided on the projecting parts 62 extended from the stopper parts 60 is desired before contact between the fixed electrode parts 38, 39 and the movable electrode parts 36, 37.

Thus, the stopper parts 60 are provided so that the gaps d31 between the movable part 33 and the projections 210 provided on the projecting parts 62 may be narrower than the gaps d1 between the movable electrode parts 36, 37 and the fixed electrode parts 38, 39. That is, the projections 210 are provided on the projecting parts 62 (62R, 62L) extended from the stopper parts 60 (60L, 60R) so that the width relationship between the gaps d1 and the gaps d3 may satisfy gap d1>gap d31.

Thereby, the functional device 1d may suppress excessive displacement of the movable part 33 by the contact between the movable part 33 and the projections 210 provided on the stopper parts 60 before the contact between the fixed electrode parts 38, 39 and the movable electrode parts 36, 37.

Further, when the movable part 33 is displaced in a second direction crossing the first direction, the stopper parts 60 (projecting parts 62) and the first beam part 34, the second beam part 35 may be brought into point contact because the projections 220 are provided on the end surfaces 64L, 64R of the projecting parts 62L, 62R. Therefore, breakage due to contact between the stopper parts 60 and the first beam part 34, the second beam part 35 may be suppressed.

In the functional device 1d, the other configurations are the same as those of the above described functional device 1 in the first embodiment, and their explanation will be omitted.

According to the above described fifth embodiment, the following advantages may be obtained.

According to the functional device 1d, the contact area when the stopper parts 60 and the movable part 33 come into contact may be made smaller compared to those of the above described functional devices 1, 1a, 1b.

Further, the projections 220 are provided on the end surfaces 64L, 64R of the stopper parts 60L, 60R opposed to the first beam part 34, the second beam part 35, and thereby, the contact area between the first beam part 34, the second beam part 35 and the stopper parts 60L, 60R may be made smaller. Therefore, sticking when the movable part 33 and the stopper parts 60L, 60R come into contact or the first beam part 34, the second beam part 35 and the stopper parts 60L, 60R come into contact may be suppressed. Further, the impact when the movable part 33 and the stopper parts 60L, 60R come into contact or the first beam part 34, the second beam part 35 and the stopper parts 60L, 60R come into contact may be reduced. Thus, breakage of the functional device 1d when the movable part 33 and the stopper parts 60L, 60R come into contact or the first beam part 34, the second beam part 35 and the stopper parts 60L, 60R come into contact may be suppressed.

Note that, in the above described functional devices 1, 1a, 1b, 1c, 1d in the first embodiment to the fifth embodiment, the forms in which the stopper parts 60, 160 are provided in line symmetry in both extension directions of the first axis of the X-axis directions (the directions of the arrow a shown in FIGS. 1, 3, 5) in which the movable part 33 is displaced have been explained. However, the forms are not limited to those as long as the stopper parts 60, 160 are provided in one direction of the X-axis directions in which the movable part 33 is displaced. Further, the explanation of the functional devices that measure physical quantities including acceleration and an angular velocity has been made as above, however, the invention may be applied to an MEMS vibrator or the like having the similar configuration.

### Working Examples

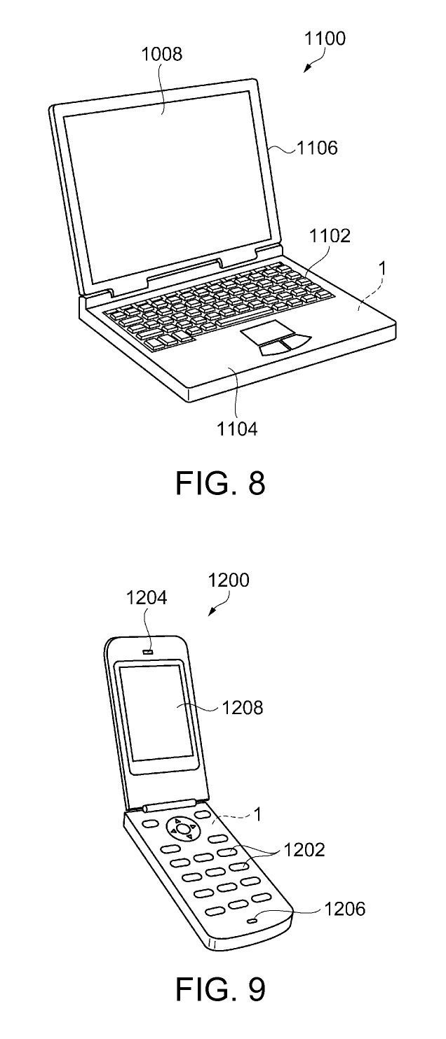

Working examples to which one of the functional devices 1, 1a, 1b, 1c, 1d (hereinafter, collectively explained as the functional device 1) according to one embodiment of the invention is applied will be explained with reference to FIGS. 8 to 11.

### Electronic Apparatuses

Electronic apparatuses to which the functional device according to one embodiment of the invention is applied will be explained with reference to FIGS. 8 to 10.

FIG. 8 is a perspective view showing an outline of a configuration of a laptop (or mobile) personal computer as an electronic apparatus including the functional device according to one embodiment of the invention. In the drawing, a laptop personal computer 1100 includes a main body unit 1104 having a keyboard 1102 and a display unit 1106 having a display part 1008, and the display unit 1106 is rotatably supported via a hinge structure part with respect to the main body unit 1104. The lap top personal computer 1100 contains the functional device 1 that functions as an acceleration sensor or the like for sensing acceleration or the like applied to the laptop personal computer 1100 and displaying the acceleration or the like on the display unit 1106. In the functional device 1, breakage due to a vibration by the operation of the laptop personal computer 1100 and an impact with drop may be suppressed, and the physical quantity may be continuously detected. Thus, the reliable laptop personal computer 1100 may be obtained.

FIG. 9 is a perspective view showing an outline of a configuration of a cell phone (including a PHS) as the electronic apparatus including the functional device according to one embodiment of the invention. In the drawing, a cell phone 1200 includes a plurality of operation buttons 1202, an ear piece 1204, and a mouthpiece 1206, and a display part 1208 is provided between the operation buttons 1202 and the ear piece 1204. The cell phone 1200 contains the functional device 1 that functions as an acceleration sensor or the like for sensing acceleration or the like applied to the cell phone 1200 and assisting the operation of the cell phone 1200. In the functional device 1, breakage due to a vibration by the operation of the cell phone 1200 and an impact with drop may be suppressed, and the physical quantity may be continuously detected. Thus, the reliable cell phone 1200 may be obtained.

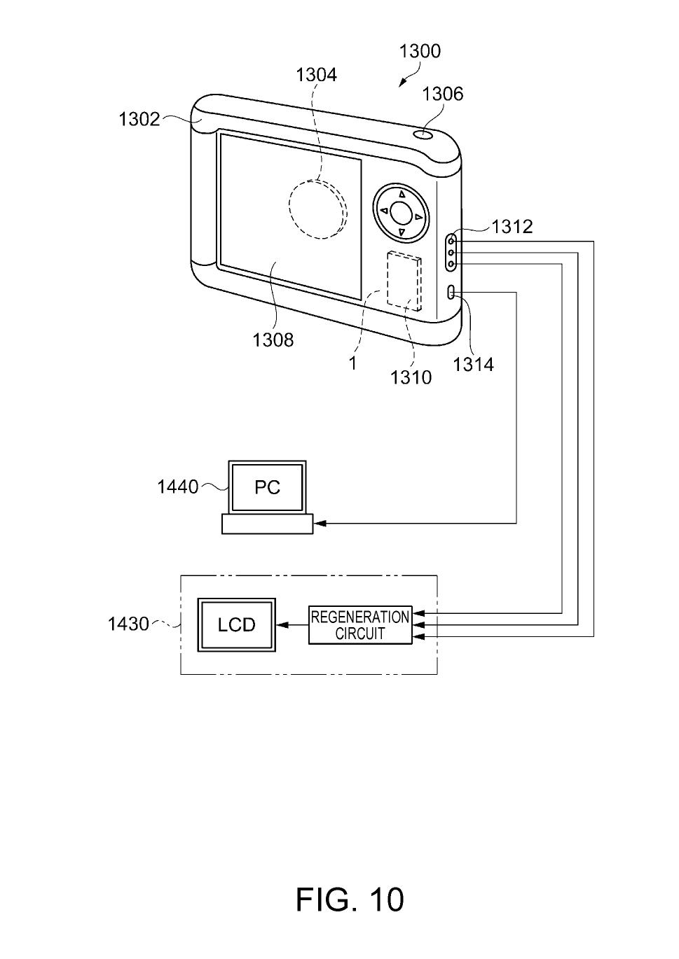

FIG. 10 is a perspective view showing an outline of a configuration of a digital still camera as the electronic apparatus including the functional device according to one embodiment of the invention. Note that, in the drawing, connection to an external device is simply shown. Here, in a typical camera, a silver halide photographic film is exposed to light by an optical image of a subject and, on the other hand, a digital still camera 1300 photoelectrically converts an optical image of a subject using an image sensing device such as a CCD (Charge Coupled Device) and generates imaging signals (image signals).

On a back surface of a case (body) 1302 in the digital still camera 1300, a display part 1308 is provided and adapted to display based on the imaging signals by the CCD, and the display part 1308 functions as a finder that displays the subject as an electronic image. Further, on the front side (the rear side in the drawing) of the case 1302, a light receiving unit 1304 including an optical lens (imaging system), the CCD, etc. is provided.

When a photographer checks the subject image displayed on the display part 1308 and presses down a shutter button 1306, the imaging signals of the CCD at the time are transferred and stored into a memory 1310. Further, in the digital still camera 1300, a video signal output terminal 1312 and an input/output terminal for data communication 1314 are provided on the side surface of the case 1302. Furthermore, as illustrated, a liquid crystal display 1430 is connected to the video signal output terminal 1312 and a personal computer 1440 is connected to the input/output terminal for data communication 1314, respectively, as appropriate. In addition, by predetermined operation, the imaging signals stored in the memory 1310 are output to the liquid crystal display 1430 and the personal computer 1440. The digital still camera 1300 contains the functional device 1 that functions as an acceleration sensor that senses acceleration due to drop for operating the function of protecting the digital still camera 1300 from drop. In the functional device 1, breakage due to a vibration by the operation of the digital still camera 1300 and an impact with drop may be suppressed, and the physical quantity may be continuously detected. Thus, the reliable digital still camera 1300 may be obtained.

Note that the functional device 1 according to one embodiment of the invention may be applied not only to the laptop personal computer (mobile personal computer) in FIG. 8, the cell phone in FIG. 9, and the digital still camera in FIG. 10 but also to an electronic apparatus including an inkjet ejection device (for example, an inkjet printer), a television, a video camera, a video tape recorder, a car navigation system, a pager, a personal digital assistance (with or without communication function), an electronic dictionary, a calculator, an electronic game machine, a word processor, a work station, a videophone, a security television monitor, electronic binoculars, a POS terminal, a medical device (for example, an electronic thermometer, a sphygmomanometer, a blood glucose meter, an electrocardiographic measurement system, an ultrasonic diagnostic system, or an electronic endoscope), a fish finder, various measurement instruments, meters and gauges (for example, meters for vehicles, airplanes, and ships), and a flight simulator, for example.

### Moving Object

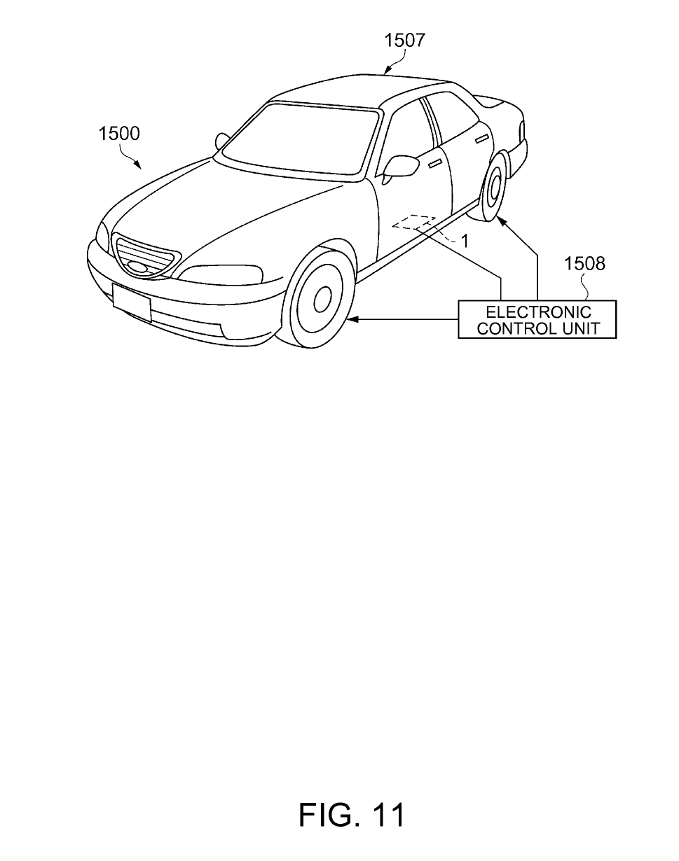

FIG. 11 is a perspective view schematically showing an automobile as an example of a moving object. In an automobile 1500, the functional device 1 that functions as an acceleration sensor is mounted on various kinds of control units. For example, as shown in the drawing, in the automobile 1500 as the moving object, an electronic control unit (ECU) 1508 that contains the functional device 1 that senses the acceleration of the automobile 1500 and controls output of the engine is mounted on a vehicle body 1507. The acceleration is sensed and the engine is controlled to appropriate output in response to the attitude of the vehicle body 1507, and thereby, the automobile 1500 as an efficient moving object with suppressed consumption of fuel or the like may be obtained.

In addition, the functional device 1 may be widely applied to a vehicle body attitude control unit, an antilock brake system (ABS), an airbag, or a tire pressure monitoring system (TPMS).

In the functional device 1, breakage due to a vibration and an impact from the automobile 1500 may be suppressed, and the physical quantity may be continuously detected. Thus, the reliable automobile 1500 may be obtained.

What is claimed is:

1. A functional device comprising:
a movable member that can be displaced along a first axis;
a movable electrode part extended from the movable member;
a fixed electrode part provided to be opposed to the movable electrode part; and
a stopper part that regulates displacement of the movable member,
wherein a projecting part projecting along the first axis is provided on the movable member, and
a distance between an end of the projecting part and the stopper part is shorter than a distance between the movable electrode part and the fixed electrode part.

2. The functional device according to claim 1, further comprising a fixed part connected to the movable member,
wherein the fixed part and the stopper part are integrally provided.

3. The functional device according to claim 1, further comprising a first fixed part and a second fixed part connected to the movable member,
wherein the first fixed part and the second fixed part are provided on both sides of the stopper part, and
the first fixed part and the movable member are connected by a first beam part and the second fixed part and the movable member are connected by a second beam part.

4. The functional device according to claim 3, wherein at least a part of the projecting part is provided between the first beam part and the second beam part.

5. The functional device according to claim 1, wherein the movable member and the stopper part are at the same potential.

6. The functional device according to claim 1, wherein a projection is provided on at least one of opposed surfaces of the stopper part and the projection part.

7. A functional device comprising:
a movable member that can be displaced along a first axis;
a movable electrode part extended from the movable member;
a fixed electrode part provided to be opposed to the movable electrode part;
a stopper part that regulates displacement of the movable member;
a first fixed part and a second fixed part provided on both sides of the stopper part;
a first beam part that connects the first fixed part and the movable member; and
a second beam part that connects the second fixed part and the movable member,
wherein the stopper part is provided to project toward the movable member, and
a distance between the stopper part and the movable member is shorter than a distance between the movable electrode part and the fixed electrode part.

8. The functional device according to claim 7, wherein at least a part of the stopper part is provided between the first beam part and the second beam part.

9. The functional device according to claim 7, wherein the movable member and the stopper part are at the same potential.

10. The functional device according to claim 7, wherein a projection is provided on a surface opposed to the movable member in the stopper part.

11. An electronic apparatus comprising the functional device according to claim 1.

12. An electronic apparatus comprising the functional device according to claim 7.

13. A moving object comprising the functional device according to claim 1.

14. A moving object comprising the functional device according to claim 7.
